(19) United States
(12) Patent Application Publication
(10) Pub. No.: US 2019/0174577 A1
(43) Pub. Date: Jun. 6, 2019

(54) ADVERTISING CO-LOCATED BASIC SERVICE SETS IN A NETWORK

(71) Applicant: QUALCOMM Incorporated, San Diego, CA (US)

(72) Inventors: Abhishek Pramod Patil, San Diego, CA (US); George Cherian, San Diego, CA (US); Alfred Asterjadhi, San Diego, CA (US)

(21) Appl. No.: 16/203,604

(22) Filed: Nov. 28, 2018

Related U.S. Application Data
(60) Provisional application No. 62/597,894, filed on Dec. 12, 2017.
(60) Provisional application No. 62/593,845, filed on Dec. 1, 2017.

(51) Int. Cl. H04W 88/10; H04W 48/16; H04W 76/11; H04W 72/04; H04W 24/08

(52) U.S. Cl. CPC H04W 88/10; H04W 48/16; H04W 84/12; H04W 72/0446; H04W 24/08; H04W 76/11

(57) ABSTRACT

Methods and apparatus for communicating in a wireless network. In one aspect, a wireless local area network (WLAN) apparatus may operate a first virtual access point (VAP) associated with a first basic service set (BSS) and at least a second VAP associated with a second BSS. The WLAN apparatus may generate and output a management frame for transmission to a first STA associated with the first BSS. The management frame may include one or more signaling attributes indicating the first VAP associated with the first BSS and the second VAP associated with the second BSS are being operated at the WLAN apparatus. The first STA may receive the management frame and determine, based on the one or more signaling attributes of the management frame, that the first VAP associated with the first BSS and the second VAP associated with the second BSS are being operated at the WLAN apparatus.

### CROSS-REFERENCE TO RELATED APPLICATIONS

This Patent Application claims priority to U.S. Provisional Patent Application No. 62/593,845 filed Dec. 1, 2017 and U.S. Provisional Patent Application No. 62/597,894 filed Dec. 12, 2017 both entitled “SYSTEMS AND METHODS FOR COMMUNICATING IN A MULTIPLE BASIC SERVICE SET NETWORK,” and assigned to the assignee hereof. The disclosure of the prior Application is considered part of and is incorporated by reference in this Patent Application.

### TECHNICAL FIELD

Certain aspects of the present disclosure generally relate to wireless communications, and more particularly, communications in a multiple basic service set network arrangement.

### DESCRIPTION OF THE RELATED TECHNOLOGY

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network can transmit/receive information between each other. Device transmissions can interfere with each other, and certain transmissions can selectively block other transmissions. Where many devices share a communication network, congestion and inefficient link usage can result. As such, systems, methods, and non-transitory computer-readable media are needed for improving communication efficiency in wireless networks.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One innovative aspect of the subject matter described in this disclosure can be implemented by a WLAN apparatus. The WLAN apparatus may operate a first virtual access point (VAP) associated with a first basic service set (BSS) and a second VAP associated with a second BSS. The WLAN apparatus may output a management frame for transmission to a first STA associated with the first BSS. The management frame may include one or more signaling attributes indicating the first VAP associated with the first BSS and the second VAP associated with the second BSS are being operated at the WLAN apparatus.

Another innovative aspect of the subject matter described in this disclosure can be implemented by a WLAN apparatus associated with a first BSS. The WLAN apparatus may receive a management frame from an access point (AP). The management frame may include one or more signaling attributes. The WLAN apparatus may determine, based on the one or more signaling attributes of the management frame, that a first VAP associated with the first BSS and a second VAP associated with a second BSS are being operated at the AP.

Another innovative aspect of the subject matter described in this disclosure can be implemented by a WLAN apparatus that comprises a processor and an interface coupled with the processor. The processor may be configured to operate, at the WLAN apparatus, a first VAP associated with a first BSS and a second VAP associated with a second BSS, and generate one or more signaling attributes indicating the first VAP associated with the first BSS and the second VAP associated with the second BSS are being operated at the WLAN apparatus. The interface may be configured to output a management frame for transmission to a first STA associated with the first BSS. The management frame may include the one or more signaling attributes.

Another innovative aspect of the subject matter described in this disclosure can be implemented by a WLAN apparatus associated with a first BSS. The WLAN apparatus may comprise an interface and a processor coupled with the interface. The interface may be configured to receive a management frame from an AP. The management frame may include one or more signaling attributes. The processor may be configured to determine, based on the one or more signaling attributes of the management frame, that a VAP associated with the first BSS and a second VAP associated with a second BSS are being operated at the AP.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 is an exemplary illustration of two access points (APs) and the associated devices in each respective basic service set (BSS).

FIG. 4 shows four BSSs, each BSS being served by the same AP.

FIG. 5 shows a flowchart for an exemplary method of advertising that wireless local area network (WLAN) apparatus is operating multiple BSSs associated with a corresponding multiple virtual APs (VAPs).

FIG. 6 shows a flowchart for an exemplary method of determining that an AP operates multiple VAPs associated with a corresponding multiple BSSs.

FIG. 7 shows an exemplary information element structure for a co-located BSSID list that can be used within a wireless communication system.

FIG. 8 shows an exemplary Neighbor Report element structure that can be used within a wireless communication system.

FIG. 9 shows an exemplary High Efficiency (HE) Operation element structure that can be used within a wireless communication system.

FIG. 10 shows an exemplary Reduced Neighbor Report (RNR) element structure that can be used within a wireless communication system.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein it will be appreciated that the scope of the disclosure is intended to cover any aspect of the novel systems, apparatuses, and methods disclosed herein, whether implemented independently of or combined with any other aspect of the disclosure. For example, an apparatus can be implemented or a method can be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), direct—sequence spread spectrum (DSSS) communications, a combination of OFDM and DSSS communications, or other schemes such as multiple-input and multiple-output (MIMO).

In some implementations, a WLAN includes various devices that access the wireless network. For example, there can be two types of devices: access points (“APs” or “AP STA”) and clients (also referred to as stations, or “STAs” or “non-AP STA”). In general, an AP serves as a hub or base station for the WLAN and an STA serves as a user of the WLAN. For example, a STA can be a laptop computer, a personal digital assistant (PDA), a mobile phone, etc. In some aspects, an STA connects to an AP via a Wi-Fi (e.g., IEEE 802.11 protocol such as 802.11ax) compliant wireless link to obtain general connectivity to the Internet or to other wide area networks (WAN). In some implementations an STA can also be used as an AP.

The techniques described herein can be used for various broadband wireless communication systems, including communication systems that are based on an orthogonal multiplexing scheme, such as Orthogonal Frequency Division Multiple Access (OFDMA). An OFDMA system utilizes orthogonal frequency division multiplexing (OFDM), which is a modulation technique that partitions the overall system bandwidth into multiple orthogonal sub-carriers. These sub-carriers can also be called tones, bins, etc.

The teachings herein can be incorporated into (e.g., implemented within or performed by) a variety of wired or wireless apparatuses (e.g., nodes). In some aspects, a wireless node implemented in accordance with the teachings herein can comprise an AP or an access terminal.

An AP can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RB S”), or some other terminology.

A STA can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

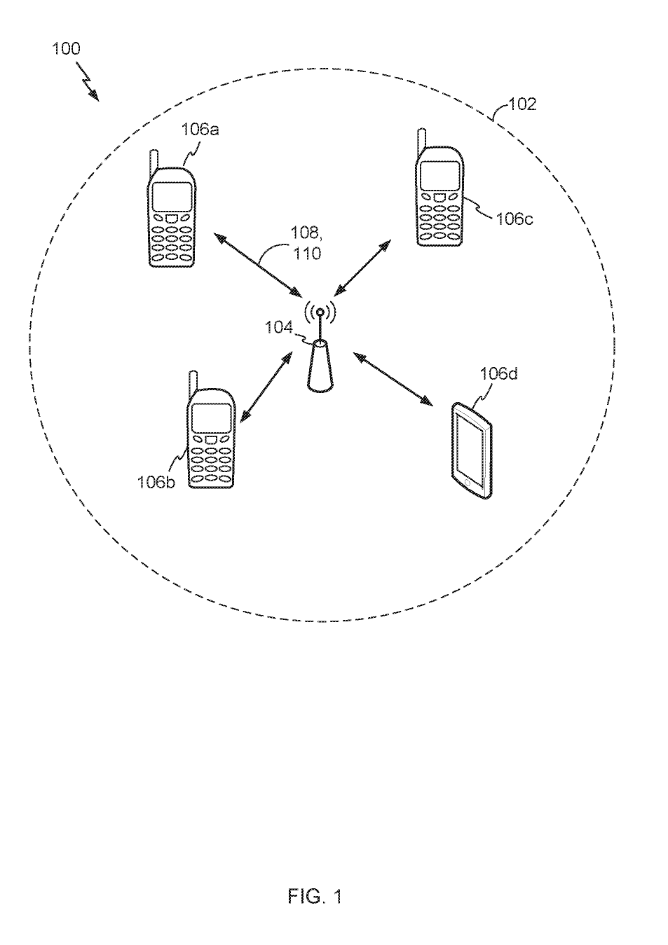

FIG. 1 illustrates an example of a wireless communication system 100 in which aspects of the present disclosure can be employed. The wireless communication system 100 can operate pursuant to an IEEE 802.11 wireless standard such as, for example, the 802.11ax standard. The wireless communication system 100 can include an AP 104, which communicates with STAs 106a-d (referred to herein as “STA 106” or “STAs 106”).

A variety of processes and methods can be used for transmissions in the wireless communication system 100 between the AP 104 and the STAs 106. For example, in some aspects signals can be transmitted and received between the AP 104 and the STAs 106 in accordance with OFDMA techniques. In accordance with these aspects, the wireless communication system 100 can be referred to as an OFDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, the DL 108 can be referred to as a forward link or a forward channel, and the UL 110 can be referred to as a reverse link or a reverse channel.

The AP 104 can provide wireless communication coverage in a basic service area (BSA) 102. The AP 104 along with the associated STAs 106 that use the AP 104 for communication can be referred to as a basic service set (BSS). Associated STAs 106 may refer to one or more associated station (e.g., STA 106a) that has performed an association procedure with the AP 104. It should be noted that the wireless communication system 100 may not have a central AP 104, and may alternatively function as a peer-to-peer network between/among the STAs 106. Accordingly, the functions of the AP 104 described herein can additionally or alternatively be performed by one or more of the STAs 106.

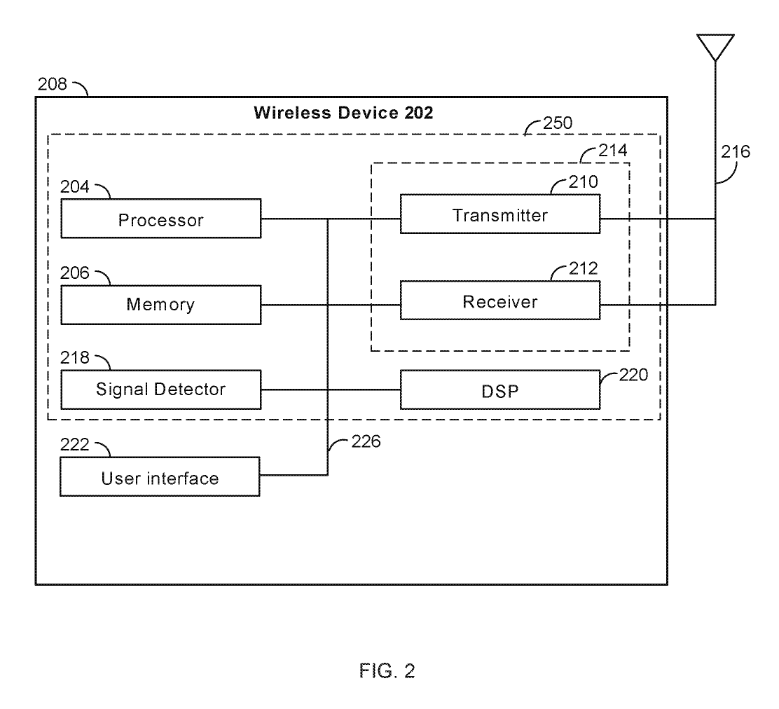

FIG. 2 illustrates various components that can be utilized in a wireless device 202 that can be employed within the wireless communication system 100 of FIG. 1, in accordance with some implementations. The wireless device 202 is an example of a device that can be configured to implement the various methods described herein. In some aspects, the wireless device 202 can comprise the AP 104 or one of the STAs 106.

As illustrated, the wireless device 202 can include a processor 204, which may be configured to control the operation of the wireless device 202. The processor 204 can also be referred to as a central processing unit (CPU). As illustrated, the wireless device 202 can also include a memory 206, which can include one or both of read-only memory (ROM) and random access memory (RAM). In some aspects, the memory 206 stores or provides instructions or data that may be utilized by the processor 204. In one aspect, a portion of the memory 206 can also include non-volatile random access memory (NVRAM). The processor 204 can be configured to perform logical and arithmetic operations based on program instructions stored within the memory 206. In some implementations, the instructions in the memory 206 can be executable (e.g., software) to implement the methods described herein.

In various aspects, the processor 204 can comprise, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). In some implementations, the instructions, when executed by the one or more processors, cause the processing system to perform the various functions described herein.

The wireless device 202 can also include a housing 208, which can include a transmitter 210 and a receiver 212 to allow transmission and reception of data between the wireless device 202 and a remote location. In some aspects, the transmitter 210 and the receiver 212 can be combined into a transceiver 214. In various aspects, an antenna 216 can be attached to the housing 208 and electrically coupled to the transceiver 214. The wireless device 202 can also include (not shown) multiple transmitters, multiple receivers, multiple transceivers, and/or multiple antennas, which can be utilized during MIMO communications, for example.

As illustrated, the wireless device 202 can also include a signal detector 218 that can be used to detect and quantify the level of signals received by the transceiver 214. In some aspects, the signal detector 218 can detect the received signals as total energy, energy per subcarrier per symbol, power spectral density and other signals. As illustrated, the wireless device 202 can also include a digital signal processor (DSP) 220 for use in processing signals. In various aspects, the DSP 220 can be configured to generate a data unit for transmission. In some aspects, the generated data unit can comprise a physical layer data unit (PPDU), which may also be referred to as a “packet,” a “message” or a “frame.”

As illustrated, the wireless device 202 can further comprise a user interface 222. In some aspects, the user interface 222 can comprise a keypad, a microphone, a speaker, or a display. In accordance with various embodiments, the user interface 222 can include any element or component that conveys information to a user of the wireless device 202 or receives input from the user.

As illustrated, the various components of the wireless device 202 can be coupled together by a system bus 226. The system bus 226 can include a data bus, for example, as well as a power bus, a control signal bus, or a status signal bus in addition to the data bus. In various aspects, the components of the wireless device 202 can be coupled together, or accept or provide inputs to each, other using some other mechanism.

In some implementations, the wireless device 202 may include a WLAN chip 250, which may also be referred to as a WLAN apparatus, that may operate pursuant to the family of IEEE 802.11 wireless standards such as, for example, the 802.11ax standard, and may perform some or all of the operations described herein this disclosure. As illustrated, in some implementations, the WLAN chip 250 may include the transceiver 214, the processor 204, the memory 206, the signal detector 218, and the DSP 220. In some implementations, the WLAN chip 250 may include a different processor or multiple processors (not shown), which are separate from (but may communicate with) the processor 204. In some implementations, the WLAN chip 250 may include a different memory and a different DSP (not shown), which are separate from (but may communicate with) the memory 206 and the DSP 220. In some implementations, the WLAN chip 250 may include one or more transceivers, such as the transceiver 214, that may operate as an interface (which may also be referred to as a network interface) to communicate with other APs 104 and STAs 106 of a WLAN. In some implementations, a WLAN apparatus may refer to any device that includes one or more components (which may include hardware, firmware, and software) that may operate pursuant to the family of IEEE 802.11 wireless standards such as, for example, the 802.11ax standard, and may perform some or all of the operations described herein this disclosure. In some implementations, a WLAN apparatus may be defined to include a STA and an AP (such as the wireless device 202) that may operate pursuant to the family of IEEE 802.11 wireless standards (and which may include one or more wireless communication devices, such as a WLAN chip). In some implementations, a WLAN apparatus may be defined to include a wireless communication chip (such as the WLAN chip 250) that may operate pursuant to the family of IEEE 802.11 wireless standards (and which may include one or more wireless communication components, such as a modem, analog front end, network interface, processor, memory, etc.).

Although a number of separate components are illustrated in FIG. 2, one or more of the components can be combined or commonly implemented. For example, the processor 204 can be used to implement not only the functionality described above with respect to the processor 204, but also to implement the functionality described above with respect to the signal detector 218 or the DSP 220. Further, each of the components illustrated in FIG. 2 can be implemented using a plurality of separate elements.

As discussed above, the wireless device 202 can comprise an AP 104 or an STA 106, and can be used to transmit and/or receive data. In some aspects, the data units exchanged between the AP 104 and the STAs 106 can include data frames, control frames, and/or management frames. Data frames can be used for transmitting data from an AP 104 or a STA 106 to other APs 104 or STAs 106. Control frames can be used together with data frames for performing various operations or for reliably delivering data (e.g., acknowledging receipt of data, polling of APs, area-clearing operations, channel acquisition, carrier-sensing maintenance functions, etc.). In some aspects, management frames can be used for various supervisory functions (e.g., for joining and departing from wireless networks, etc.).

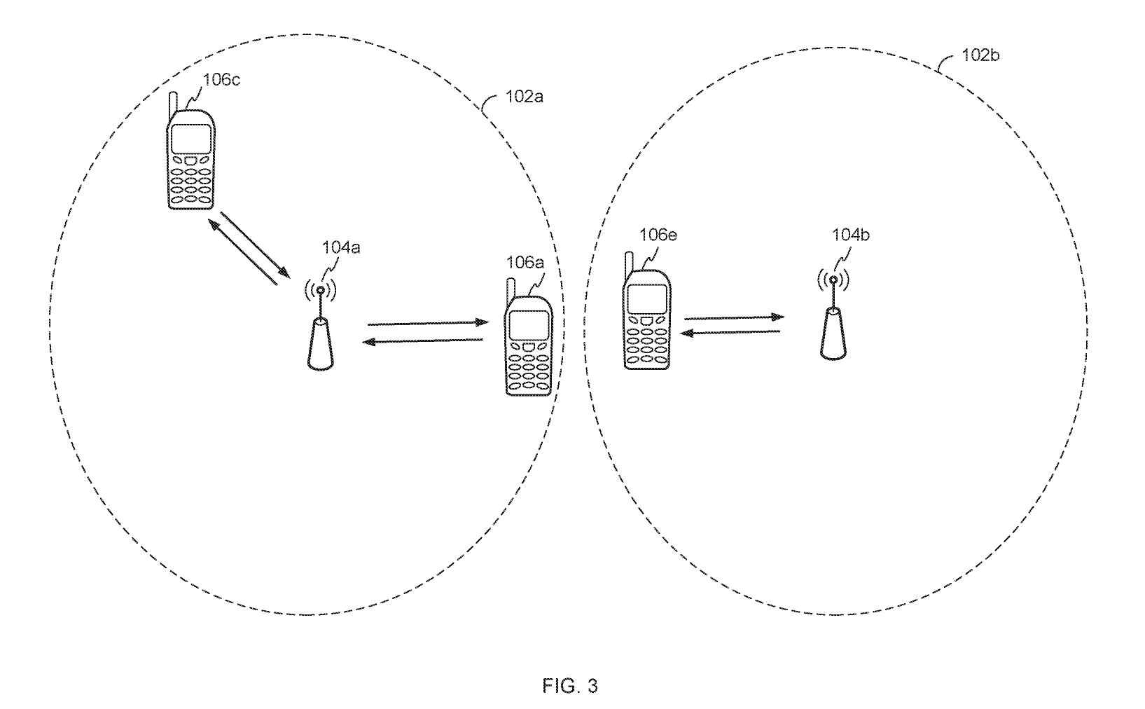

FIG. 3 is an exemplary illustration of two APs and the associated devices in each respective BSS, in accordance with some implementations. As noted above, the BSS may refer to an AP 104 along with the associated STAs 106 that use the AP 104 for communication. For example, as illustrated, the AP 104a may have a BSS 102a, which comprises associated STAs 106a-d, though only STAs 106a and 106c are shown. In some aspects, the phrase “BSSA” may refer to the area which the AP 104a services. Although illustrated here as a circle, this coverage of the BSS 102a is merely illustrative.

The AP 104a may be associated with any number of different STAs. For example, the AP 104a may be associated with more or less than the two illustrated STAs 106a, 106c. Within some geographical proximity to the AP 104a, there may also be other APs, such as AP 104b. The AP 104b may have a BSS, such as BSS 102b, which may comprise one or more STAs, such as STA 106e. Although the BSS of the AP 104a and the AP 104b are not illustrated as overlapping, in some aspects, the BSS 102a from one AP 104a may overlap with the BSS 102b from another AP 104b, or the BSSA (not illustrated) of one AP 104a may overlap with the BSSA of another AP 104b. In dense deployments, there may be a large number of overlapping BSSs from various APs (also referred to herein as a plurality of wireless communication networks). Each of the BSSs may be based on the same protocols, such as a particular IEEE 802.11 protocol, or may be based on different protocols. Similarly, these BSSs may use the same portion of the spectrum, such as using the same channel and band (e.g., overlapping or partially overlapping), or may use adjacent or different channels and bands. In some aspects, a channel may comprise a bandwidth, and the bandwidth may be regarded as comprising more than one sub-band (e.g., 5 MHz, 10 MHz, 20 MHz, 40 MHz, 80 MHz, etc.). In accordance with these aspects, BSSs may be regarded as utilizing overlapping or partially overlapping bandwidths or sub-bands of a channel, or adjacent or different sub-bands of a channel.

APs with Multiple Basic Service Set Identifiers (BSSIDs)/Co-Located APs

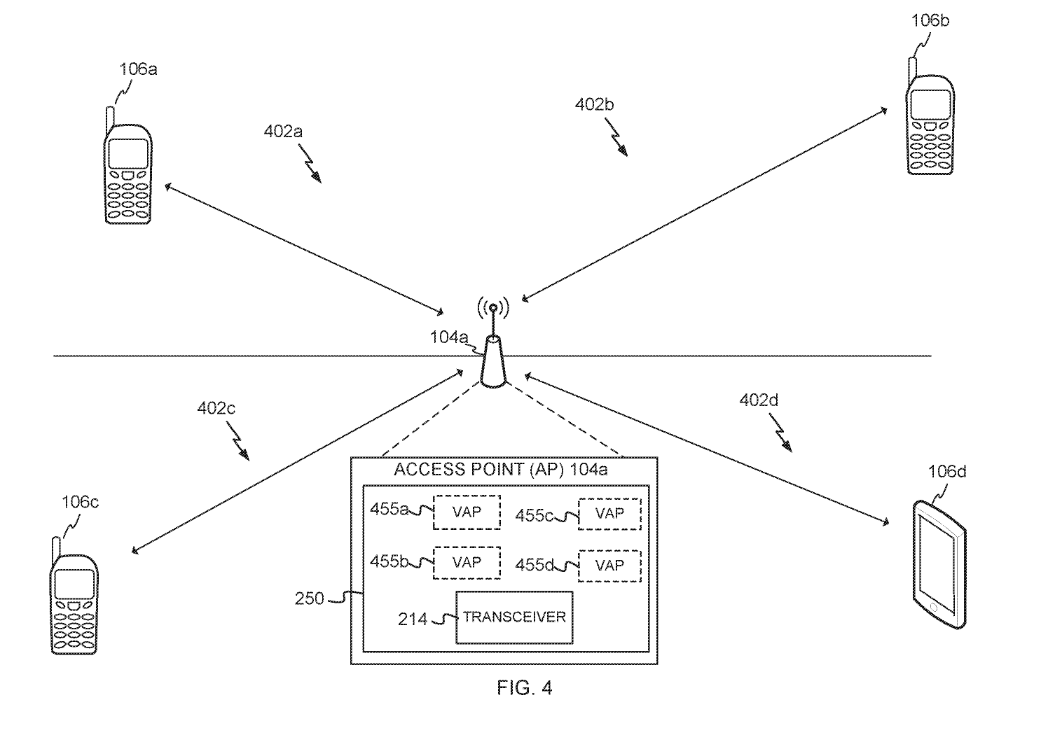

FIG. 4 shows four BSSs 402a-d, each BSS being served by the same AP 104a. The AP 104a is associated with at least one STA within its respective BSS 402a-d. Thus, the AP 104a is associated with STA 106a-d. Associations between an AP 104 and one or more STAs 106 provides for, in part, coordination of communication between devices within the BSS defined by the AP 104 and its associated STAs 106. For example, devices within each BSS may exchange signals with each other. The signals may function to coordinate transmissions from the respective AP 104a-d and STAs within the AP's BSS 402a-d.

The devices shown in FIG. 4, including the AP 104a and STAs 106a-d, also share a wireless medium. Sharing of the wireless medium is facilitated, in some aspects, via the use of carrier sense media access with collision detection (CSMA/CD). The disclosed implementations may provide for a modified version of CSMA/CD that provides for an increase in an ability to communicate simultaneously within the BSSs 402a-d when compared to known systems.

In such a configuration as shown in FIG. 4, the AP 104a may be a single physical AP 104 that serves or supports the BSSs 402a-d. Accordingly, the AP 104a may act as multiple access points (or operate multiple virtual access points (“VAPs”)), one for each BSSID of the multiple BSSs 402a-d. Each of the VAPs may function, at least in part, with different parameters (e.g., a different BSSID, different security settings or parameters, etc.). For example, the AP 104a may support a secured BSS 402a and the guest BSSs 402b-d in a single location or area. In some implementations, the multiple BSSs 402a-d served by the AP 104a may operate in a single frequency. In some embodiments, each of the VAPs (and each of the BSSs) may be assigned a different color, and may operate in a different channel and band. In some implementations, one or more VAPs (and BSSs) may share a particular color, and may also operate in the same channel and band.

In some implementations, the AP 104a that serves multiple BSSs 402a-d via multiple VAPs may support a multiple BSSID mode or capability. Under such multiple BSSID mode, only one of the multiple VAPs served by the AP 104a may transmit its BSSID. The remaining VAPs served by the AP 104a may not transmit their BSSIDs. Instead, the VAP that transmits its BSSID may transmit an element (e.g., a multiple BSSID element) in management frames (such as beacon frames and probe response frames) that includes information for the non-transmitted BSSIDs. When a management frame includes the multiple BSSID element, this may indicate that the VAP transmitting the multiple BSSID element belongs to a multiple BSSID set. The multiple BSSID set may be a special case of a co-located BSSID set, in that all of the VAPs may use a common operating class, channel, band, and antenna connectors, and have the capability to advertise information for the multiple BSSID set using a single management frame (such as a single beacon frame or probe response frame) instead of using multiple management frames (i.e., one management frame for each VAP). The multiple BSSID element may include fields identifying other BSSIDs, VAPs, and various parameters (e.g., color) of those other BSSIDs and VAPs. Accordingly, STAs 106 that are able to support the multiple BSSID mode or capability may receive the multiple BSSID element, obtain the information of all VAPs and BSSIDs supported or served by the AP 104a, and associate with the proper BSSID and VAP. Having only one VAP broadcast its BSSID may reduce overhead (e.g., beacon traffic that would otherwise exist for each of the multiple VAPs) and/or network traffic and congestion. In some implementations, a bit or field in an element (such as an High Efficiency (HE) Operation element) in a management frame may be used to indicate if the VAP sending the management frame does not belong to a multiple BSSD set, and instead belongs to a co-hosted BSSID set (where each VAP separately sends a management frame).

When BSSs are part of a multiple BSS set, each BSS may be assigned the same color. In a crowded area with multiple APs 104 that support multiple BSSID mode or capability, each AP 104 transmitting may have a different BSS color. Based on the BSS color, a STA 106 can determine whether a received communication is from the BSSID with which the STA 106 is associated (or a BSSID of the multiple BSS set) or another BSSID. Based on this determination, the STA 106 can determine whether or not the STA 106 can go to sleep, perform spatial reuse on top of the received communication, etc. In some implementations, spatial reuse may only be permitted when the BSS color of the received communication is different from the BSS color of the BSSID to which the STA 106 belongs.

However, in some implementations, the AP 104a does not support the multiple BSSID mode or capability. The AP 104a may not have a single VAP broadcasting its BSSID, and instead have each of the VAPs served or hosted by the AP 104a broadcast respective BSSIDs for the BSSs 402a-d. This may be referred to as the co-located BSS mode or capability. In some implementations, the AP 104a may support both the co-located BSS mode or capability and the multiple BSSID mode or capability, and the AP 104a may switch from one mode to the other (for example, depending on whether any STAs in the network do not support the multiple BSSID mode or capability). The co-located mode or capability may allow STAs 106 that do not support the multiple BSSID mode or capability to still associate with the AP 104a hosting multiple BSSs 402a-d. Additionally, the AP 104a may allow each served VAP to broadcast its own BSS color or may restrict all served VAPs to broadcast the same BSS color. If all the BSSs 402a-d of the served VAPs use the same BSS color without signaling by the AP 104a (or the VAPs) to indicate that the BSSs 402a-d belong to the same AP 104a, the STAs 106 may report a color collision case, which may result in unexpected behavior by the STAs 106. Therefore, the AP 104a may signal and identify each BSS that it hosts.

Accordingly, a STA 106 in the area may detect each of the broadcast BSSIDs and may determine that each BSS 402a-d is supported by a separate physical AP 104. Thus, the STA 106 that associates with a first VAP having a first BSSID may assume that communications received or observed on a second BSSID served by the AP 104a are inter-BSS communications. Additionally, since each of the VAPs may or may not have their own assigned BSS color, the STA 106 may be unable to determine that communications from a VAP, other than the first VAP, are intra-BSS communications. Accordingly, the STA 106 may assume that it can perform spatial reuse on one of the assumed “inter-BSS communications” not knowing that such spatial reuse may be detrimental to communications of its AP 104a. Similarly, the STA 106 may assume that communications received having the same BSS color as the BSSID to which the STA 106 belongs are intra-BSS communications and may not sleep, etc., when those communications are instead part of another BSSID and VAP.

Accordingly, rules may be useful to help STAs 106 determine when multiple VAPs may be supported by the AP 104a and when the AP 104a does not support the multiple BSSID mode or capability. Such rules may help the AP 104a to identify to STAs 106 that all the BSSIDs are supported by a single physical AP 104 (e.g., the AP 104a) but different VAPs. For example, as shown in FIG. 4, the AP 104a may host VAPs 455a-455d that are associated with corresponding BSSs 402a-d. In some implementations, the AP 104a may operate and host the VAPs 455a-d using the WLAN chip 250 (also shown in FIG. 2). In some implementations, communications (such as management frames) from the VAPs 455a-d may be processed by the transceiver 214 of the WLAN chip 250 prior to outputting the communications via an interface for transmission to one or more devices of the WLAN. In some implementations, rules may also instruct or inform the STAs 106 to treat all frames and/or communications received from the BSSIDs supported by the AP 104a as intra-BSS communications. Thus, the STAs may be prevented from performing spatial reuse on these communications. Additionally, the rules may allow the STA to determine whether or how to set inter- or intra- network allocation vector (NAV) timers, inter- or intra-PPDU timers, spatial reuse capabilities, etc. and what BSSIDs are served by the AP 104a.

Once the observed transmission is determined to be inter- or intra-BSS, the STA 106 can perform different actions. For example, if the observed transmission is an intra-BSS transmission, then the receiving STA 106 can go to sleep temporarily (e.g., following intra-BSS power save functionality) because the STA 106 belonging to the same BSSID as the receiving STA 106 is performing a transaction and only one transaction can occur at a given time in the corresponding BSS. For example, the STA 106 may set its intra-NAV, which may allow the STA 106 to know how long the current transmission is expected to last and instructs the STA 106 to refrains from accessing the medium until that time passes. Additionally, the STA 106 may know that spatial reuse is not available since the communication is intra-BSS. On the other hand, if the STA 106 determines that the observed transmission is an inter-BSS transmission, the STA 106 should know not to go to sleep because one or more intra-BSS communications directed to the STA 106 may be transmitted by the VAP with which the STA 106 is associated, depending on the likelihood of interference. Thus, the STA 106 may need to be awake for the duration of the inter-BSS communication. Such rules may assist STAs 106 in identifying an observed or received communication as an inter-BSS or intra-BSS communication when the AP 104a has multiple VAPs but does not support multiple BSSID mode or capability.

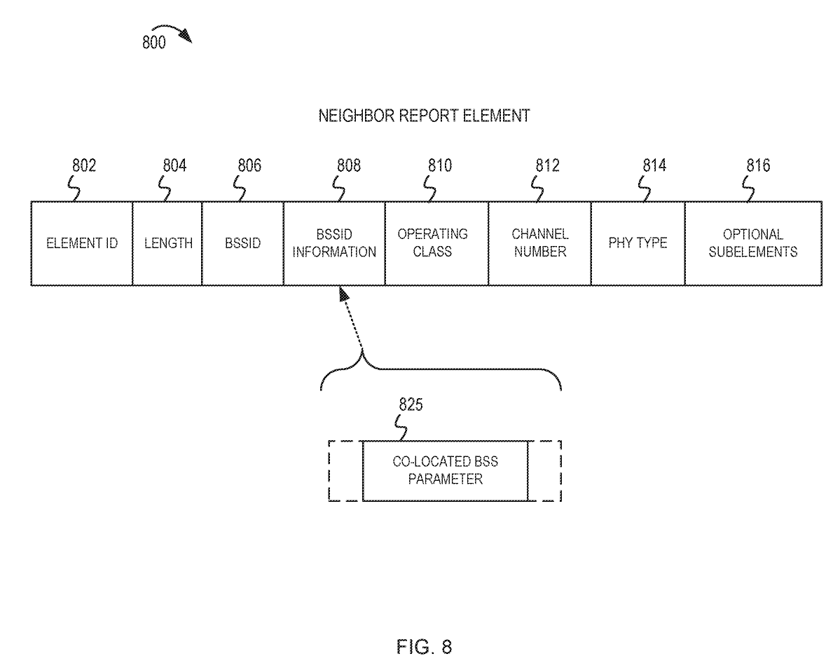

In some implementations, a VAP may transmit a Neighbor Report element. In some implementations, each of the VAPs operating in the AP 104a may transmit Neighbor Report elements. A Neighbor Report element may be transmitted periodically in beacon frames or may be transmitted at any time via other management frames (such as probe response or (re)association response frames). The Neighbor Report element may be used to inform receiving STAs what APs identified in the Neighbor Report element are neighboring APs. The Neighbor Report element may include capabilities and various information of the neighboring APs. In some implementations, the Neighbor Report element may include an indication to indicate that neighboring APs identified in the Neighbor Report element are VAPs supported and operating in the same AP 104a as the VAP transmitting the Neighbor Report element. In some implementations, the indication may be a bit or a field (which may be referred to as a co-located BSS bit or subfield, or a co-hosted BSS bit or subfield) included in the Neighbor Report element, as described further in FIG. 8. For example, the bit or field may be an existing reserved bit or field, a repurposed bit or field, or a new bit or field. In some implementations, a Neighbor Report element may include information about a single co-located or co-hosted VAP, and thus a VAP may transmit multiple Neighbor Report elements to identify and provide information about multiple co-located or co-hosted VAPs in the same physical device (such as AP 104a). For example, the bit of the Neighbor Report element, when equal to “1”, may indicate that a corresponding identifier in the Neighbor Report element is a co-located or co-hosted VAP of the AP 104a. Otherwise, the bit may be set to “0.” The Neighbor Report element may also include other information (such as channel number, operating class, BSSID, SSID, etc.) about the co-located or co-hosted VAP and the corresponding BSS.

In some implementations, “co-located” VAPs may be broadly defined to include all of the VAPs that are operating in the same physical device (such as the AP 104a), whether the VAPs use the same or different channels and bands (such as the 2.4 GHz band, the 5 GHz band, or the 6 GHz band), and whether the VAPs use the same or different antenna connectors. For example, an AP that operates a first VAP associated with a first BSS in a first channel of the 5 GHz band, and a second VAP associated with a second BSS in a second channel of the 6 GHz band may be considered to have “co-located” VAPs and the corresponding BSSs. Also, the first VAP may use a first antenna connector (e.g., associated with the 5 GHz band) and the second VAP may use a second antenna connector (e.g., associated with the 6 GHz band). In some implementations, a “co-hosted” VAP may be defined as a special type of a co-located VAP, in that “co-hosted” VAPs are VAPs that operate in the same physical device (such as the AP 104a), and may operate on the same frequency channel and band. Co-hosted VAPs may also share the same antenna connector. For example, an AP that operates a first VAP associated with a first BSS and a second VAP associated with a second BSS in the same channel (e.g., the first channel) of the same band (e.g., the 5 GHz band) and using the same antenna connectors (e.g. associated with the 5 GHz band) may be considered to have “co-hosted” VAPs and the corresponding BSSs. In some implementations, a set of VAPs operating on the same physical device (whether the VAPs use the same or different channels and bands and whether the VAPs use the same or different antenna connectors) may also be referred to as a co-located BSSID set. Furthermore, a set of VAPs operating on the same physical device that use a common operating class, channel, band, and antenna connectors may also be referred to as a co-hosted BSSID set. It is noted, however, that in some implementations, “co-located” and “co-hosted” may be used interchangeably, and may be broadly defined to include all of the VAPs that are served by the same physical device (such as the AP 104a), whether the VAPs use the same or different bands and channels, and whether the VAPs use the same or different antenna connectors.

In some implementations, an element (e.g., VAP or virtual neighbor element) may be transmitted by the AP 104. In some implementations, each of the VAPs supported by the AP 104 may transmit this element. In some implementations, the element could include a list of BSSIDs supported by the VAPs served or supported by the AP 104a. This list could identify particular full addresses or partial address of the BSSs that are operating in the physical AP. In some implementations, the list could identify full or partial addresses of the VAPs. The STAs receiving the element may use the included list to determine which received or observed communications are intra- or inter-BSS communications. For example, communications from the BSSIDs that are listed in the element may be intra-BSS transmissions, and communications from BSSIDs that are not listed in the element may be inter-BSS transmissions.

In some implementations, a spatial reuse element may be configured to include information regarding VAPs of the AP 104a. The spatial reuse element may be used to convey information about a neighborhood of the transmitting AP and receiving STA. For example, the spatial reuse element may be directed to or identify a spatial reuse group (SRG). The spatial reuse element may identify all the BSSIDs that belong to the SRG. In some implementations, the AP 104a may add the BSSIDs of the VAPs to the SRG, thus preventing spatial reuse on communications from the identified BSSIDs. In addition to preventing spatial reuse, the spatial reuse element may include identifiers or indicators for a STA to set intra-NAV, intra-PPDU rules, etc., based on observing or receiving communications from any BSSIDs identified in the spatial reuse element that belong to the SRG. In some implementations, a field may be added to the SRG to identify that particular BSSIDs are VAPs and instructing STAs to treat communications observed or received from these BSSIDs as intra-BSS communications and to apply all corresponding intra-BSS rules to communications observed or received these BSSIDs.

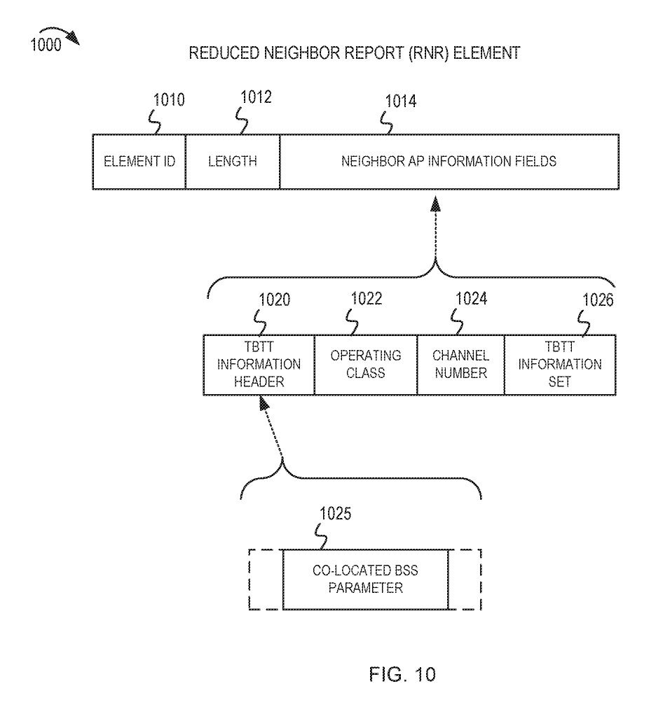

In some implementations, a VAP may transmit a Reduced Neighbor Report (RNR) element to identify neighboring APs that are VAPs supported and operating in the same physical device, such as AP 104a. An RNR element may be transmitted periodically in beacon frames or may be transmitted at any time via other management frames (such as probe response or (re)association response frames). In some implementations, the RNR element may include an indication to indicate that neighboring APs identified in the RNR element are VAPs supported and operating in the same physical AP (such as the AP 104a) as the VAP transmitting the RNR element. In some implementations, the indication may be a bit or a field (which may be referred to as a co-located BSS bit or subfield, or a co-hosted BSS bit or subfield) included in the RNR element, as described further in FIG. 10. For example, the bit or field may be an existing reserved bit or field, a repurposed bit or field, or a new bit or field. In some implementations, an RNR element may include information (such as channel number, operating class, BSSID, SSID, etc.) about multiple co-located or co-hosted VAPs. For example, as described further in FIG. 10, the RNR element may include multiple entries or a list of entries, where each entry includes information (such as channel number, operating class, BSSID, SSID, etc.) about one of the VAPs.

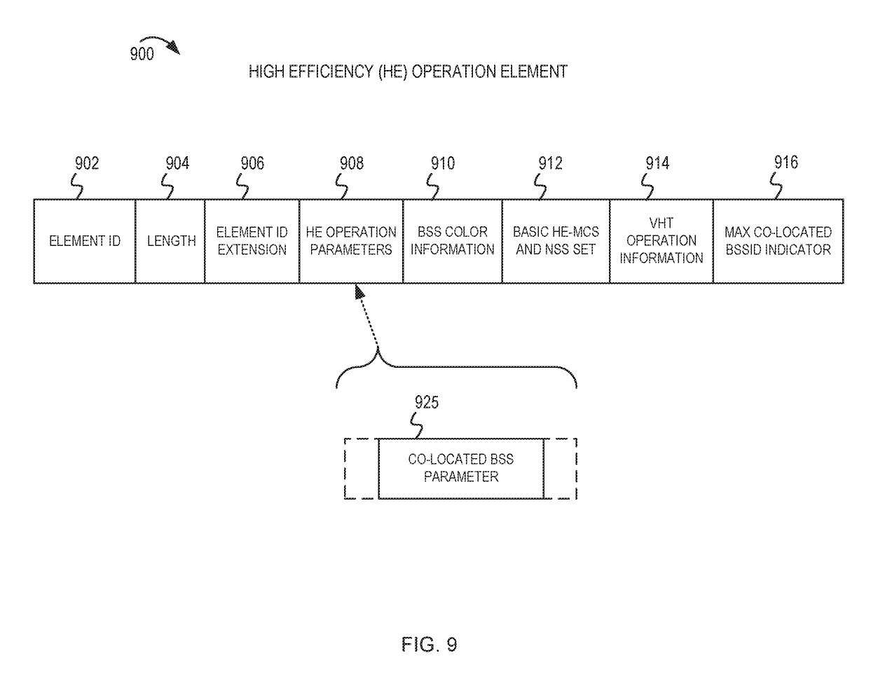

In some implementations, a VAP may transit a High Efficiency (HE) Operation element that indicates the VAP transmitting the HE Operation element is part of a set of co-located or co-hosted VAPs that are operating in the same physical device (such as AP 104a). An HE Operation element may be transmitted periodically in beacon frames or may be transmitted at any time via other management frames (such as probe response or (re)association response frames). In some implementations, the HE Operation element may include a bit or a field (which may be referred to as a co-located BSS bit or subfield, or a co-hosted BSS bit or subfield) to indicate the VAP transmitting the HE Operation element is part of a set of co-located or co-hosted VAPs, as described further in FIG. 9. For example, the bit or field may be an existing reserved bit or field, a repurposed bit or field, or a new bit or field. In some implementations, the HE Operation element may also include a field that indicates a range of BSSIDs that may correspond to the set of co-located or co-hosted VAPs, as described further in FIG. 9. In some implementations, a VAP does not have to exist for every BSSID in the range of BSSIDs; however, a VAP that is associated with a BSSID in the range is part of the set of co-located or co-hosted VAPs. The HE Operation element may also include other information (such as channel number, operating class, BSSID, SSID, BSS color, etc.) about the co-located or co-hosted VAPs and the corresponding BSSs.

In some implementations, the AP 104a may use one or more of the Neighbor Report element, the VAP or virtual neighbor element, the RNR element, the HE Operation element, or the spatial reuse element in combination to signal information to STAs 106. For example, a VAP that is served by the AP 104a may transmit one or more management frames that include one or more of the Neighbor Report element, the VAP or virtual neighbor element, the RNR element, the HE Operation element, or the spatial reuse element. In some implementations, other information elements of management frames may be used to advertise the co-located or co-hosted VAPs associated with the BSSs that are operating in the same physical device (such as the AP 104a).

Such implementations described herein may allow the AP 104a to signal information regarding VAPs that are served by the AP 104 so that STAs associated with one of the VAPs served by the AP 104a can identify other VAPs served by the AP 104a. With knowledge of what VAPs (and thus, BSSIDs) are served by the AP 104a, the STAs may identify which communications are as intra-BSS communications or inter-BSS communications. Furthermore, the STAs may be able to apply appropriate intra-BSS rules to the intra-BSS communications and appropriate inter-BSS rules to the inter-BSS communications.

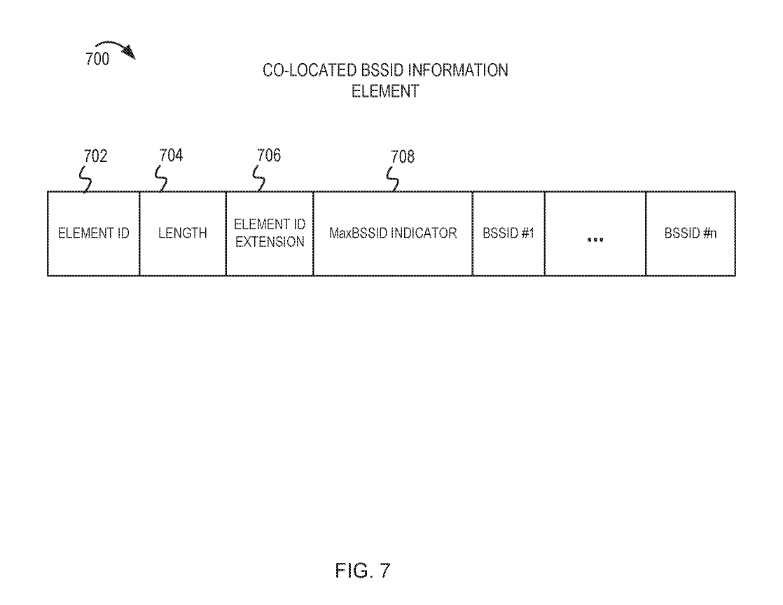

In some implementations, a co-located BSSID list sub-element may be used to report a list of BSSIDs of the BSSs which are operating in the same physical AP, such as the AP 104a. For example, the format of the co-located BSSID list sub-element may include a sub-element ID field, which may be equal to a value identifying a co-located BSSIDs list element format, a length field, a MaxBSSID indicator field, and BSSID #1-n fields, as described further in FIG. 7.

In some implementations, as noted herein, the AP 104a may advertise a co-located or co-hosted BSSID list. Such an AP 104a may be referred to as a high efficiency (HE) AP 104a. In some implementations, one or more of the co-located or co-hosted BSSs identified in the co-located or co-hosted BSSID list may be supported by legacy (e.g., non-HE) APs 104. Thus, a single physical AP 104 may provide both HE VAPs and legacy VAPs. In some implementations, the HE VAPs may advertise all co-located or co-hosted BSSs, regardless of whether or not the co-located or co-hosted BSSs are supported by HE or legacy VAPs. In some implementations, the legacy VAPs may or may not advertise any other or all other co-located or co-hosted BSSs, regardless of whether or not they are supported by HE or legacy VAPs. In some implementations, STAs 106 that identify communications on other BSSs may not perform spatial reuse on any HE or legacy communications on co-located or co-hosted BSSs. For example, in some implementations, the co-located or co-hosted BSSID may identify which BSSs are HE or legacy, and the STAs 106 may determine that spatial reuse may not be performed on any legacy communications for legacy BSSs that are co-located or co-hosted with the BSS of the STA 106a.

In some implementations, a STA 106a may determine that a PPDU received is an inter-BSS or intra-BSS frame based on various rules. For example, if the received PPDU is a legacy PPDU (e.g., a very high throughput (VHT) PPDU) including a parameter having a partial Association ID (AID) value not equal to the final 8-bits of the BSS (e.g., BSSID[39:47]) or the BSSID of any BSS that is identified as a co-located (or co-hosted) BSS and having a GROUP_ID=0, then the STA 106a may classify the received PPDU as an inter-BSS frame.

In some implementations, if the STA 106a receives a PPDU that carries a frame having a BSSID field including a value that is not the BSSID of the BSS or any BSS that is identified as a co-located or co-hosted BSS, then the STA 106a may classify the received PPDU as an inter-BSS frame.

In some implementations, if the STA 106a receives a PPDU that carries a frame that does not have a BSSID field but does include both a receive address (RA) field and a transmit address (TA) field, neither of which includes a value equal to the BSSID of the BSS or the BSSID of any BSS that is identified as a co-located (or co-hosted) BSS, then the STA 106a may classify the received PPDU as an inter-BSS frame. An individual/group bit in the TA field may be changed to “0” prior to comparison.

In some implementations, a STA 106a may determine that a received PPDU is an intra-BSS frame when the PPDU is a VHT PPDU having a partial AID value equal to the BSSID[39:47] bits of the BSS or of any BSS that is identified as a co-located (or co-hosted) BSS, and when the parameter GROUP_ID is equal to “0.” In some implementations, the STA 106a may determine that the PPDU received is an intra-BSS frame when the PPDU carries a frame that has an RA, TA, or BSSID field value that is equal to the BSSID of the BSS or the BSSID of any BSS that is identified as a co-located (or co-hosted) BSS, and when the individual/group bit in the TA field value is changed to the value 0 prior to the comparison. In some implementations, the STA 106a may determine that the received PPDU is an intra-BSS frame when the PPDU carries a control frame that does not have a TA field and that has an RA field value that matches the saved transmission opportunity (TXOP) holder address of the BSS or any BSS that is identified as a co-located (or co-hosted) BSS.

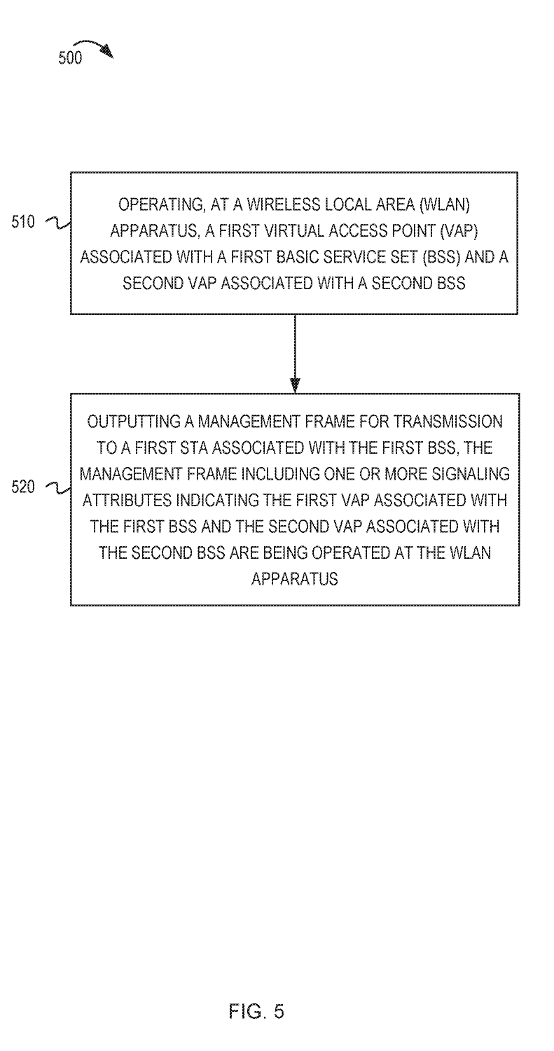

FIG. 5 shows a flowchart 500 for an exemplary method of advertising that wireless local area network (WLAN) apparatus is operating multiple BSSs associated with a corresponding multiple virtual APs (VAPs). In some implementations, the WLAN apparatus may be an AP (such as the AP 104a), or may be a WLAN chip of an AP. The WLAN apparatus may communicate with a first station (e.g., STA 106a) in a first BSS (e.g., BSS 402a) that is operating in the WLAN apparatus, and may communicate with a second STA (e.g., STA 106b) in a second BSS (e.g., BSS 402b) that is also operating in the WLAN apparatus. The method can be implemented in whole or in part by the devices described herein, such as the wireless device 202 or the WLAN chip 250 shown in FIG. 2. Although the illustrated method is described herein with reference to the wireless communication system discussed above with respect to FIGS. 1, 3, and 4, a person having ordinary skill in the art will appreciate that the illustrated method can be implemented by another device described herein, or any other suitable device. Although the illustrated method is described herein with reference to a particular order, in some implementations, blocks herein can be performed in a different order, or omitted, and additional blocks can be added.

In some implementations, at block 510 of FIG. 5, the WLAN apparatus may operate a first VAP associated with a first BSS and a second VAP associated with a second BSS (which may be referred to as co-located or co-hosted VAPs, or co-located or co-hosted BSSs).

At block 520, the WLAN apparatus may output a management frame for transmission to a first STA associated with the first BSS. The management frame may include one or more signaling attributes indicating the first VAP associated with the first BSS and the second VAP associated with the second BSS are being operated at the WLAN apparatus. The one or more signaling attributes may also be referred to as co-located or co-hosted BSS attributes or indicators.

In some implementations, the one or more signaling attributes may further indicate that the second VAP is a neighbor AP of the first VAP, and that the second VAP is co-located with the first VAP in the WLAN apparatus. The one or more signaling attributes may be included in a Neighbor Report element of the management frame. For example, as described in FIG. 8, the one or more signaling attributes may include a bit of the Neighbor Report element that indicates the second VAP associated with the second BSS is co-located or co-hosted in the same physical device (e.g., the WLAN apparatus) as the first VAP associated with the first BSS.

In some implementations, the one or more signaling attributes may include a list of BSSs associated with a set of VAPs that are co-located in the WLAN apparatus. The list of BSSs may include at least the second BSS associated with the second VAP. For example, the list of BSSs may identify one or more VAPs that are neighbor APs and also co-located in the same physical device (e.g., the WLAN apparatus) as the first VAP associated with the first BSS. In some implementations, the list of BSSs may include portions of addresses of the first BSS and the second BSS, or full addresses of the first BSS and the second BSS. The one or more signaling attributes may be included in a Reduced Neighbor Report (RNR) element of the management frame. For example, as described in FIG. 10, the one or more signaling attributes may include one or more bits of one or more fields of the RNR element.

In some implementations, the one or more signaling attributes may further indicate the first VAP is a co-located VAP, the first VAP being co-located with at least the second VAP in the WLAN apparatus. In some implementations, the one or more signaling attributes may further indicate a range of addresses of BSSs. At least a subset of the range of addresses of the BSSs are associated with a set of VAPs that are co-located by the WLAN apparatus, where the set of VAPs include at least the first VAP associated with the first BSS and the second VAP associated with the second BSS. The one or more signaling attributes may be included in a High Efficiency (HE) Operation element of the management frame. For example, as described in FIG. 9, the one or more signaling attributes may include one or more bits of one or more fields of the HE Operation element.

In some implementations, as described herein, the WLAN apparatus may switch between operating in a multiple BSSID mode, or operating in a co-located BSS mode. In some implementations, the WLAN apparatus may determine at least one of the first STA and the second STA does not support a multiple BSSID mode. In response to determining at least one of the first STA and the second STA does not support a multiple BSSID mode, the WLAN apparatus may change from operating in the multiple BSSID mode to operating in a co-located BSS mode prior to preparing and outputting the management frame.

In some implementations, the WLAN apparatus can transmit one or more signaling attributes to the first STA in the first BSS that the WLAN apparatus is communicating with the second STA in the second BSS. For example, the WLAN apparatus may transmit the one or more signaling attributes to the STA 106a in the BSS 402a indicating that the WLAN apparatus is communicating with the STA 106b in the BSS 402b.

In some implementations, the one or more signaling attributes further indicate that spatial reuse in the first BSS is not permitted on top of communications detected in the second BSS based on the first VAP associated with the first BSS being co-located with the second VAP associated with the second BSS in the WLAN apparatus. In some implementations, the WLAN apparatus may communicate with the STA 106a in the BSS 402a on a first portion of a first channel and with the STA 106b in the BSS 402b on a second portion of the first channel. In some implementations, the WLAN apparatus may further signal to the STA 106b in the BSS 402b that the WLAN apparatus is communicating with the STA 106a in the BSS 402a. In some implementations, the BSS 402a may have a first BSS attribute (e.g., color) and the BSS 402b may have a second BSS attribute. In some implementations, the first BSS attribute may comprise a first BSS color and the second BSS attribute comprises a second BSS color. In some implementations, the first BSS color and the second BSS color are different (e.g., when the first and second VAPs are co-located VAPs), while in some implementations, the first BSS color and the second BSS color are the same (e.g., when the first and second VAPs are co-hosted VAPs).

In some implementations, the method shown in FIG. 5 can be implemented in a wireless device that can include a transmitter circuit. Those skilled in the art will appreciate that a wireless device can have more components than the simplified wireless device described herein. The wireless device described herein includes only those components useful for describing some prominent features of implementations within the scope of the claims.

The transmitter circuit can be configured to transmit one or more messages, fields, or signals. In some implementations, the transmitter circuit can be configured to perform at least blocks 510 and 520 of FIG. 5. The transmitter circuit can include one or more of the transmitter 210, the transceiver 214, the processor 204, and the antenna 216 of FIG. 2. As described in this disclosure (such as FIG. 2), the WLAN chip 250 of FIG. 2 may include the transmitter circuit. In some implementations, means for transmitting can include the transmitter circuit.

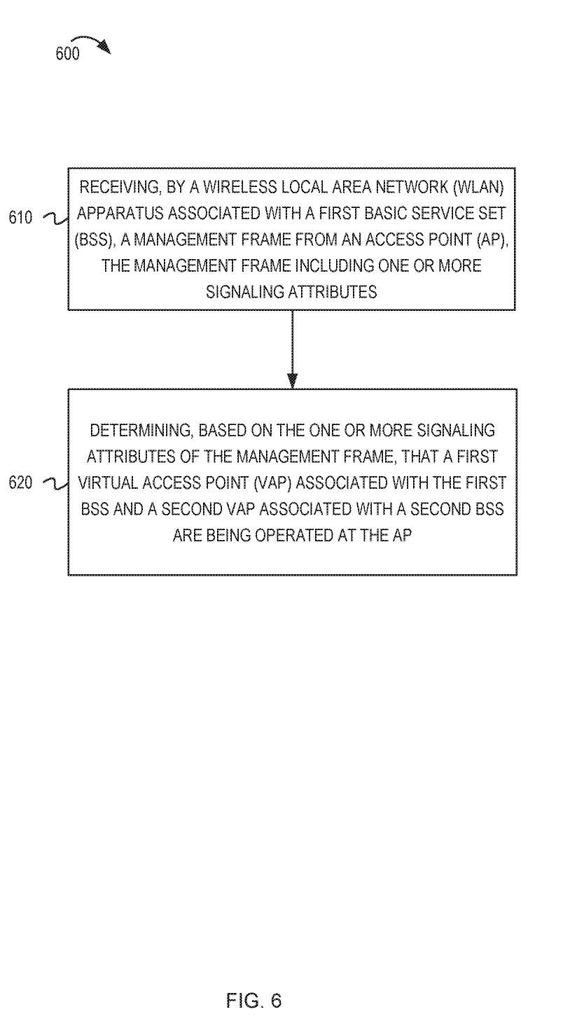

FIG. 6 shows a flowchart 600 for an exemplary method of determining, by a WLAN apparatus, that an AP operates multiple VAPs associated with a corresponding multiple BSSs. In some implementations, the WLAN apparatus may be a STA (such as a STA 106), or may be a WLAN chip of a STA. The AP (e.g., AP 104a) may operate a first VAP associated with a first BSS (e.g., BSS 402a) and at least a second VAP associated with a second BSS (which may be referred to as co-located or co-hosted VAPs, or co-located or co-hosted BSSs). The method can be implemented in whole or in part by the devices described herein, such as the wireless device 202 or the WLAN chip 250 shown in FIG. 2. Although the illustrated method is described herein with reference to the wireless communication system discussed above with respect to FIGS. 1, 3, and 4, a person having ordinary skill in the art will appreciate that the illustrated method can be implemented by another device described herein, or any other suitable device. Although the illustrated method is described herein with reference to a particular order, in some implementations, blocks herein can be performed in a different order, or omitted, and additional blocks can be added.

In some implementations, the WLAN apparatus is associated with a first BSS. At block 610 of FIG. 6, the WLAN apparatus may receive a management frame from the AP, the management frame including one or more signaling attributes. The one or more signaling attributes may also be referred to as co-located or co-hosted BSS attributes or indicators.

At block 620, the WLAN apparatus may determine, based on the one or more signaling attributes of the management frame, that the first VAP associated with the first BSS and the second VAP associated with the second BSS are being operated at the AP.

In some implementations, the WLAN apparatus may determine, based on the one or more signaling attributes, that the second VAP is a neighbor AP of the first VAP, and that the second VAP is co-located with the first VAP in the AP. The one or more signaling attributes may be included in a Neighbor Report element of the management frame. For example, as described in FIG. 8, the one or more signaling attributes may include a bit of the Neighbor Report element that indicates the second VAP associated with the second BSS is co-located or co-hosted in the same physical device (e.g., the AP) as the first VAP associated with the first BSS.

In some implementations, the WLAN apparatus may determine, based on the one or more signaling attributes, a list of BSSs associated with a set of VAPs that are co-located by the AP. The list of BSSs may include at least the second BSS associated with the second VAP. For example, the list of BSSs may identify one or more VAPs that are neighbor APs and also co-located in the same physical device (e.g., the AP) as the first VAP associated with the first BSS. In some implementations, the list of BSSs may include portions of addresses of the first BSS and the second BSS, or full addresses of the first BSS and the second BSS. The one or more signaling attributes may be included in a Reduced Neighbor Report (RNR) element of the management frame. For example, as described in FIG. 10, the one or more signaling attributes may include one or more bits of one or more fields of the RNR element.

In some implementations, the WLAN apparatus may determine, based on the one or more signaling attributes, that the first VAP is a co-located VAP, the first VAP being co-located with at least the second VAP in the AP. In some implementations, the WLAN apparatus may determine a range of addresses of BSSs based on the one or more signaling attributes. At least a subset of the range of addresses of the BSSs are associated with a set of VAPs that are co-located in the AP, where the set of VAPs include at least the first VAP associated with the first BSS and the second VAP associated with the second BSS. The one or more signaling attributes may be included in a High Efficiency (HE) Operation element of the management frame. For example, as described in FIG. 9, the one or more signaling attributes may include one or more bits of one or more fields of the HE Operation element.

In some implementations, the one or more signaling attributes further indicate that spatial reuse in the first BSS is not permitted on top of communications detected in the second BSS based on the first VAP associated with the first BSS being co-located with the second VAP associated with the second BSS in the AP. In some implementations, the first BSS may have a first BSS attribute (e.g., color) and the second BSS may have a second BSS attribute. In some implementations, the first BSS attribute comprises a first BSS color and the second BSS attribute comprises a second BSS color. In some implementations, the first BSS color and the second BSS color are different, while in some implementations, the first BSS color and the second BSS color are the same. In some implementations, the WLAN apparatus may further determine that frames communicated in the second BSS are intra-BSS frames based on the first VAP associated with the first BSS being co-located with the second VAP associated with the second BSS in the AP. In some implementations, the WLAN apparatus may further determine an intra-network allocation vector (NAV) value for the intra-BSS frames and may enter a power save mode during intra-BSS frames for a duration equal to or greater than the intra-NAV value. In some implementations, the WLAN apparatus may refrain from performing spatial reuse on top of the intra-BSS frames. In some implementations, the WLAN apparatus may perform spatial reuse on top of frames communicated in a third BSS when the AP is not indicated as hosting or operating the third BSS (and therefore the frames may be considered inter-BSS frames).

In some implementations, the method shown in FIG. 6 can be implemented in a wireless device that can include a receiver circuit or a processing circuit. Those skilled in the art will appreciate that a wireless device can have more components than the simplified wireless device described herein. The wireless device described herein includes only those components useful for describing some prominent features of implementations within the scope of the claims.

The receiver circuit can be configured to receive one or more messages, fields, or signals. In some implementations, the receiver circuit can be configured to perform at least blocks 610 and 620 of FIG. 6. The receiver circuit can include one or more of the receiver 212, the transceiver 214, the processor 204, and the antenna 216 of FIG. 2. As described in this disclosure (such as FIG. 2), the WLAN chip 250 of FIG. 2 may include the receiver circuit. In some implementations, means for receiving can include the receiver circuit.

FIG. 7 shows an exemplary co-located BSSID information element structure that can be used within the wireless communication system described in FIGS. 1-6. The co-located BSSID element 700 may be used to report a list of BSSIDs of the BSSs which are co-located or co-hosted by the same physical AP (such as the AP 104a) when the AP 104a is not operating in the Multiple BSSID mode. As shown, the co-located BSSID element includes an ID field 702 (which may be 1 byte in length), a length field 704 (which may be 1 byte in length), an element ID extension field 706 (which may be 1 byte in length), a MaxBSSID indicator field 708 (which may be 1 byte in length), and optional BSSID fields #1-n (which may be lengths 0 or 6 bytes). The ID field 702, the length field 704, and the element ID extension field 706 may be defined according to general procedures (for example, as defined by the family of IEEE 802.11 wireless standards). The MaxBSSID indicator field 708, when set to a nonzero value (n), may indicate a maximum possible number of BSSs (2ⁿ), including a reference BSS (e.g., the BSS that the STA 106a and the AP 104a are communicating over), which share the same antenna connector(s) and have the same 48-n most significant bits (MSBs) of the BSSIDs. When the BSSIDs of the co-located BSSs are configured at the AP 104a, but not represented by the MaxBSSID indicator field 708, the BSSID fields #1-n may be present in the co-located BSSID element 700 to provide a list of such BSSID values. When the MaxBSSID indicator field 708 is equal to zero, the BSSID fields #1-n contain a list of the BSSID values of the BSSs which are co-located or co-hosted by the same physical AP (such as the AP 104a).

For example, if the AP 104a and the STA 106a are communicating over a BSS and there are 4 additional BSSs which are co-located or co-hosted as the BSS over which the AP 104a and the STA 106a are communicating, and their BSSIDs end with 16, 24, 30 and 31. The range of MAC addresses ending with 16-31, inclusive, may not be assigned to other BSSs using a different antenna connector, then this list of 4 BSSIDs can be indicated with a value of 5 in the MaxBSSID indicator field 708. Otherwise, the MaxBSSID indicator field 708 is set to zero and the BSSIDs are listed separately in the BSSIDs #1-n.

In some implementations, an AP 104a may indicate that the Multiple BSSID mode is active at the AP 104a. When the Multiple BSSID mode is active, the AP 104a need not advertise a co-located BSS with the co-located BSSID element 700 or any other element (e.g., neighbor report element, etc.) in any frames transmitted by the AP 104a. In some implementations, when the AP 104a supports the co-located BSS mode, the AP 104a may transmit the co-located BSSID list in a beacon frame (or other management frames) when the AP 104a is not actively supporting the Multiple BSSID mode and the multiple BSSs are being operated in the AP 104a. Accordingly, association and reassociation response frames transmitted by the AP 104a may also include the co-located BSSID list when the AP 104a is not actively supporting the Multiple BSSID mode and the multiple BSSs are being operated in the AP 104a. Similarly, probe response frames transmitted by the AP 104a may also include the co-located BSSID list when the AP 104a is not actively supporting the Multiple BSSID mode and the multiple BSSs are being operated in the AP 104a.

FIG. 8 shows an exemplary Neighbor Report element structure that can be used within the wireless communication system described in FIGS. 1-6. The Neighbor Report element 800 may be used by an AP (such as a first VAP of an AP) to report a neighbor AP to devices (such as STAs) in the WLAN, and also indicate whether the neighbor AP is a co-located VAP (a second VAP operating in the AP). For example, the first VAP that is associated with a first BSS and the second VAP that is associated with a second BSS may be co-located or co-hosted in the same physical device (such as the AP).

In some implementations, the Neighbor Report element 800 may include an element ID 802, a length 804, a BSSID 806, BSSID information 808, an operating class 810, a channel number 812, a PHY type 814, and optional subelements 816. In some implementations, the BSSID information 808 may include a co-located BSS parameter 825. The BSSID information 808 may include one or more additional parameters that are not shown for simplicity. In some implementations, the Neighbor Report element 800 may include different fields, additional fields, or less fields than the fields shown in FIG. 8. The element ID 802, the length 804, the BSSID 806, the BSSID information 808, the operating class 810, the channel number 812, the PHY type 814, and the optional subelements 816 may be defined according to general procedures (for example, as defined by the family of IEEE 802.11 wireless standards). In some implementations, the co-located BSS parameter 825 may also be referred to as the co-hosted BSS parameter. The co-located BSS parameter 825 may also be referred to as a signaling attribute or indicator, or a co-located (or co-hosted) BSS attribute or indicator.

In some implementations, a WLAN apparatus (such as an AP) may generate and transmit, via a first VAP, a management frame that includes the Neighbor Report element (such as Neighbor Report element 800). In some implementations, as described in FIGS. 4-6 of this disclosure, the co-located (or co-hosted) BSS parameter 825 may be a bit that indicates whether the neighbor AP identified in the Neighbor Report element is a co-located (or co-hosted) VAP that is operating in the same physical device (such as the WLAN apparatus) as the first VAP (which may be referred to as the reporting AP or reporting VAP). For example, when the co-located BSS parameter 825 includes a value of ‘1’, the co-located BSS parameter 825 may indicate that the neighbor AP is a co-located VAP. When the co-located BSS parameter 825 includes a value of ‘0’, the co-located BSS parameter 825 may indicate that the neighbor AP is not co-located (or co-hosted) in the same physical device, and thus it is a separate AP in the WLAN.

FIG. 9 shows an exemplary HE Operation element structure that can be used within the wireless communication system described in FIGS. 1-6. The HE Operation element 900 may be used by an AP (such as a first VAP of an AP) to indicate the first VAP is a co-located VAP. For example, the first VAP that is associated with a first BSS may use the HE Operation element 900 to indicate to devices (such as STAs) in the WLAN that the first VAP (also referred to as the reporting VAP) is co-located or co-hosted in the same physical device (such as the AP) as one or more additional VAPs (such as a second VAP).

In some implementations, the HE Operation element 900 may include an element ID 902, a length 904, an element ID extension 906, HE operation parameters 908, a BSS color information 910, a basic HE-MCS and NSS set 912, VHT operation information 914, and a max co-located BSSID indicator 916. In some implementations, the HE operation parameters 908 may include a co-located BSS parameter 925. The HE operation parameters 908 may include one or more additional parameters that are not shown for simplicity. In some implementations, the HE Operation element 900 may include different fields, additional fields, or less fields than the fields shown in FIG. 9. The element ID 902, the length 904, the element ID extension 906, the HE operation parameters 908, the BSS color information 910, the basic HE-MCS and NSS set 912, and the VHT operation information 914 may be defined according to general procedures (for example, as defined by the family of IEEE 802.11 wireless standards). In some implementations, the max co-located BSSID indicator 916 and the co-located BSS parameter 925 may also be referred to as a max co-hosted BSSID indicator and a co-hosted BSS parameter, respectively. The max co-located BSSID indicator 916 and the co-located BSS parameter 925 may also be referred to as signaling attributes or indicators, or co-located (or co-hosted) BSS attributes or indicators.

In some implementations, a WLAN apparatus (such as an AP) may generate and transmit a management frame via a first VAP that includes the HE Operation element (such as the HE Operation element 900). In some implementations, as described in FIGS. 4-6 of this disclosure, the co-located (or co-hosted) BSS parameter 925 may be a bit that indicates whether the first VAP is a co-located (or co-hosted) VAP that is operating in the same physical device (such as the WLAN apparatus) as one or more additional VAPs (such as a second VAP). For example, when the co-located BSS parameter 925 includes a value of ‘1’, the co-located BSS parameter 925 may indicate that the first VAP (which is the reporting VAP) is a co-hosted VAP. When the co-located BSS parameter 925 includes a value of ‘0’, the co-located BSS parameter 925 may indicate that the first VAP (which is the reporting VAP) is not co-located or co-hosted in the same physical device (such as the WLAN apparatus) as additional VAPs.

In some implementations, when the first VAP (which is the reporting VAP) is a co-located or co-hosted VAP, the max co-located BSSID indicator 916 may indicate a range of address of the BSSs that may be co-located or co-hosted BSSs. In some implementations, at least a subset (some or all) of the range of BSS addresses may be associated with a set of VAPs that are co-located or co-hosted by the WLAN apparatus. For example, the set of VAPs may include the first VAP (which is the reporting VAP) that is associated with a first BSS and a second VAP that is associated with a second BSS. In some implementations, the max co-located BSSID indicator 916, when set to a nonzero value (n), may indicate a maximum possible number of co-located or co-hosted BSSs (2ⁿ), including the first BSS associated with the first VAP (which is the reporting VAP). The value n may indicate a range of BSS addresses having the same 48-n most significant bits (MSBs) of the BSSIDs. For example, when n=2, the co-located BSSID indicator 916 indicates there is a maximum of 4 co-located or co-hosted BSSs, which have addresses that include the same 48-n (e.g., 46 when n=2) MSBs in the BSSIDs. In some implementations, the max co-located BSSID indicator 916 may be set to zero (n=0) when the co-located BSS parameter 925 is set to zero.

FIG. 10 shows an exemplary Reduced Neighbor Report (RNR) element structure that can be used within the wireless communication system described in FIGS. 1-6. The RNR element 1000 may be used by an AP (such as a first VAP of an AP) to report one or more neighbor APs to devices (such as STAs) in the WLAN, and also indicate whether the neighbor AP(s) are a co-located VAP (such as a second VAP of the AP). For example, the first VAP that is associated with a first BSS and the second VAP that is associated with a second BSS may be co-located or co-hosted in the same physical device (such as the AP).

In some implementations, the RNR element 1000 may include an element ID 1010, a length 1012, and neighbor AP information fields 1014. In some implementations, the neighbor AP information fields 1014 may include information about one or more neighboring APs, including a target beacon transmit time (TBTT) information header 1020, an operating class 1022, a channel number 1024, and a TBTT information set 1026. In some implementations, the TBT information header 1020 may include a co-located BSS parameter 1025. The TBT information header 1020 may include one or more additional parameters that are not shown for simplicity. In some implementations, the RNR element 1000 may include different fields, additional fields, or less fields than the fields shown in FIG. 10. The element ID 1010, the length 1012, the neighbor AP information fields 1014, the TBTT information header 1020, the operating class 1022, the channel number 1024, and the TBTT information set 1026 may be defined according to general procedures (for example, as defined by the family of IEEE 802.11 wireless standards). In some implementations, the co-located BSS parameter 1025 may also be referred to as a co-hosted BSS parameter 1025. The co-located BSS parameter 1025 may also be referred to as a signaling attribute or indicator, or a co-located (or co-hosted) BSS attribute or indicator.

In some implementations, a WLAN apparatus (such as an AP) may generate and transmit a management frame via a first VAP that includes the RNR element (such as the RNR element 1000). In some implementations, as described in FIGS. 4-6 of this disclosure, the co-located BSS parameter 1025 may be a bit that indicates whether the corresponding neighbor AP identified in the RNR element is a co-located VAP that is operating in the same physical device (such as the WLAN apparatus) that hosts the first VAP (which may be referred to as the reporting AP or reporting VAP). For example, when the co-located BSS parameter 1025 includes a value of ‘1’, the co-located BSS parameter 1025 may indicate that the neighbor AP is a co-located VAP. When the co-located BSS parameter 1025 includes a value of ‘0’, the co-located BSS parameter 1025 may indicate that the neighbor AP is not co-located or co-hosted in the same physical device, and thus it is a separate AP in the WLAN.

In some implementations, as described in FIGS. 4-6 of this disclosure, the RNR element 100 may include a list of BSSs, each BSS having a separate co-located BSS parameter 1025 to indicate whether the BSS is a co-located BSS. The list of BSSs may be one or more BSSs that are associated with one or more VAPs that are co-located VAPs (e.g., the entries in the list that have a co-located BSS parameter 1025 equal to 1), and may also include one or more BSSs that are associated with one or more neighbor APs that are not co-located VAPs (e.g., the entries in the list that have a co-located BSS parameter 1025 equal to 0).

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, the terms “and” or “or” may be interchangeable, and may be interpreted as “and/or” (e.g., anywhere from one to all of the items in a list).

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. A method performed by a wireless local area network (WLAN) apparatus, comprising:
operating, at the WLAN apparatus, a first virtual access point (VAP) associated with a first basic service set (BSS) and a second VAP associated with a second BSS; and
outputting a management frame for transmission to a first STA associated with the first BSS, the management frame including one or more signaling attributes indicating the first VAP associated with the first BSS and the second VAP associated with the second BSS are being operated at the WLAN apparatus.

2. The method of claim 1, wherein the one or more signaling attributes further indicating the second VAP is a neighbor AP of the first VAP and the second VAP is co-located with the first VAP in the WLAN apparatus.

3. The method of claim 2, wherein the one or more signaling attributes are included in a Neighbor Report element of the management frame.

4. The method of claim 1, wherein the one or more signaling attributes include a list of BSSs associated with a set of VAPs that are co-located in the WLAN apparatus, the list of BSSs including at least the second BSS associated with the second VAP.

5. The method of claim 4, wherein the one or more signaling attributes are included in a Reduced Neighbor Report element of the management frame.

6. The method of claim 1, wherein the one or more signaling attributes further indicating the first VAP is a co-located VAP, the first VAP being co-located with at least the second VAP in the WLAN apparatus.

7. The method of claim 6, wherein the one or more signaling attributes further indicating a range of addresses of BSSs, wherein at least a subset of the range of addresses of the BSSs are associated with a set of VAPs that are co-located in the WLAN apparatus, the set of VAPs including at least the first VAP associated with the first BSS and the second VAP associated with the second BSS.

8. The method of claim 6, wherein the one or more signaling attributes are included in a High Efficiency (HE) Operation element of the management frame.

9. The method of claim 1, further comprising:
outputting management frames for transmission using the first VAP associated with the first BSS and the second VAP associated with the second BSS,
wherein the first VAP associated with the first BSS and the second VAP associated with the second BSS being operated at the WLAN apparatus are co-located VAPs, and if the first VAP and the second VAP use the same channel, band, and antenna connectors, the first VAP and the second VAP are co-hosted VAPs, a co-hosted VAP being a type of a co-located VAP.

10. The method of claim 1, wherein the one or more signaling attributes further indicate that spatial reuse in the first BSS is not permitted on top of communications detected in the second BSS based, at least in part, on the first VAP associated with the first BSS being co-located with the second VAP associated with the second BSS in the WLAN apparatus.

11. The method of claim 1, further comprising:
determining at least one of the first STA and the second STA does not support a multiple BSSID mode; and
in response to determining at least one of the first STA and the second STA does not support a multiple BSSID mode, changing from operating in the multiple BSSID mode to operating in a co-located BSS mode prior to preparing and outputting the management frame.

12. A method performed by a wireless local area network (WLAN) apparatus, the WLAN apparatus associated with a first basic service set (BSS), comprising:
receiving a management frame from an access point (AP), the management frame including one or more signaling attributes; and
determining, based on the one or more signaling attributes of the management frame, that a first virtual access point (VAP) associated with the first BSS and a second VAP associated with a second BSS are being operated at the AP.

13. The method of claim 12, further comprising determining, based on the one or more signaling attributes, that the second VAP is a neighbor AP of the first VAP and the second VAP is co-located with the first VAP in the AP.

14. The method of claim 13, wherein the one or more signaling attributes are included in a Neighbor Reporting element of the management frame.

15. The method of claim 12, further comprising determining, based on the one or more signaling attributes, a list of BSSs associated with a set of VAPs that are co-located in the AP, the list of BSSs including at least the second BSS associated with the second VAP.

16. The method of claim 15, wherein the one or more signaling attributes are included in a Reduced Neighbor Report element of the management frame.

17. The method of claim 12, further comprising determining, based on the one or more signaling attributes, that the first VAP is a co-located VAP, the first VAP being co-located with at least the second VAP in the AP.

18. The method of claim 17, further comprising determining, based on the one or more signaling attributes, a range of addresses of BSSs, wherein at least a subset of the range of addresses of BSSs are associated with a set of VAPs that are co-located in the AP, the set of VAPs including at least the first VAP associated with the first BSS and the second VAP associated with the second BSS.

19. The method of claim 17, wherein the one or more signaling attributes are included in a High Efficiency (HE) Operation element of the management frame.

20. The method of claim 12, further comprising determining that frames communicated in the second BSS are intra-BSS frames based, at least in part, on determining that the first VAP associated with the first BSS is co-hosted with the second VAP associated with the second BSS in the AP.

21. The method of claim 20, further comprising determining an intra-network allocation vector (NAV) value for the intra-BSS frames.

22. The method of claim 21, further comprising entering a power save mode for a duration equal to or greater than the intra-NAV value.

23. The method of claim 20, further comprising refraining from performing spatial reuse on top of the intra-BSS frames.

24. The method of claim 12, further comprising performing spatial reuse in the first BSS on top of frames communicated in a third BSS, wherein the AP is not indicated as operating the third BSS.

25. A WLAN apparatus comprising:
a processor configured to:
operate, at the WLAN apparatus, a first virtual access point (VAP) associated with a first basic service set (BSS) and a second VAP associated with a second BSS, and
generate one or more signaling attributes indicating the first VAP associated with the first BSS and the second VAP associated with the second BSS are being operated at the WLAN apparatus; and
an interface coupled with the processor, the interface configured to output a management frame for transmission to a first STA associated with the first BSS, the management frame including the one or more signaling attributes.

26. The WLAN apparatus of claim 25, wherein the one or more signaling attributes further indicating the second VAP is a neighbor AP of the first VAP and the second VAP is co-located with the first VAP in the WLAN apparatus.

27. The WLAN apparatus of claim 25, wherein the one or more signaling attributes further indicating the first VAP is a co-located VAP, the first VAP being co-located with at least the second VAP in the WLAN apparatus.

28. A WLAN apparatus associated with a first basic service set (BSS), the WLAN apparatus comprising:
an interface configured to receive a management frame from an access point (AP), the management frame including one or more signaling attributes; and
a processor coupled with the interface, the interface configured to determine, based on the one or more signaling attributes of the management frame, that a first virtual access point (VAP) associated with the first BSS and a second VAP associated with a second BSS are being operated at the AP.

29. The WLAN apparatus of claim 28, wherein the processor is further configured to determine, based on the one or more signaling attributes, that the second VAP is a neighbor AP of the first VAP and the second VAP is co-located with the first VAP in the AP.

30. The WLAN apparatus of claim 28, wherein the processor is further configured to determine, based on the one or more signaling attributes, that the first VAP is a co-located VAP, the first VAP being co-located with at least the second VAP in the AP.
